(19) United States
(12) Patent Application Publication
(10) Pub. No.: US 2008/0225137 A1
(43) Pub. Date: Sep. 18, 2008

(54) IMAGE INFORMATION PROCESSING APPARATUS

(76) Inventors: Yuichi Kubo, Odawara (JP); Hiroshi Chiba, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/869,234

(22) Filed: Oct. 9, 2007

(30) Foreign Application Priority Data
Mar. 13, 2007 (JP) 2007-062763

(51) Int. Cl. H04N 5/232; H04N 5/76; H04N 7/18; G03B 13/00; H04N 7/00

(52) U.S. Cl. 348/231.2; 348/349; 348/116; 348/157

(57) ABSTRACT

An image information processing apparatus which uses more than one wireless IC tag to detect the information concerning a present position of a target object to be shot and which senses an image of the object based on the position information is disclosed. This apparatus is operative in corporation with the wireless tag to display on a monitor screen the information as to the object position and output it in an audible form. Additionally, in the case of more than two target objects being present, the apparatus manages the priority orders thereof.

### INCORPORATION BY REFERENCE

The present application claims priority from Japanese application JP 2007-62763 filed on Mar. 13, 2007, the content of which is hereby incorporated by reference into this application.

### BACKGROUND OF THE INVENTION

The present invention relates to image information processing apparatus.

In JP-A-09-023359, JP-A-09-074504 and JP-A-09-074512, a technique is disclosed for using an infrared radiation (IR) sensor to attain an objective of “providing a means for shooting a specific target subject without requiring any special photographic skills in cases where a photographer wants to shoot his or her child among many children who are similar in costume in people-gathered events, e.g., an athletic festival in school.”

JP-A-2005-229494 discloses therein a means for attaining an objective of “reliably specifying the position of a photographic subject even in those circumstances with difficulties in specifying the photographic subject.” In this respect, the published Japanese patent application involves a written teaching which follows: “Optical data, such as an infrared light signal, which is output from an identification (ID) information output unit 210 being attached to part of the photographic subject, is received by an image sensing means 1 together with an image signal of the shooting subject, which unit extracts therefrom only infrared band components for output to an infrared position detecting means 14. Then, specify its on-screen position for output to a control means 13 as position information. The control means 13 displays it at a display means 12 while superimposing a marker thereon based on the position information.”

### SUMMARY OF THE INVENTION

In order to shoot a photographic subject of interest by using an image pickup device, such as a video camera, also known as camcorder, what must be done first by a photographer is to pre-recognize where the target subject exists. Traditionally, this has been attained by direct look with eyes or, alternatively, by judgment while looking at an image of the shooting subject being seen in a finder of the image pickup device or being displayed on a display device. However, in a situation that many children who wear similar clothes are present, such as a supports festival, it is usually difficult to promptly find the aimed child from among them for shooting purposes.

In JP-A-09-023359, JP-A-09-074504, JP-A-09-074512 and JP-A-2005-229494 it is proposed to use an IR sensor in such the situation. In this case if a present position of the shooting subject is predictable on the photographer's side then face the image pickup device toward an imagable area in the direction in which the shooting subject is present whereby an imager unit receives and senses infrared light coming from an infrared ray output unit being attached to the shooting subject so that it becomes possible to detect a present position of the subject. Note here that in case the shooting subject is promptly findable, it is possible to direct the image pickup device to the subject and shoot it in a “point-and-shoot” manner; however, it is difficult to shoot the subject when its present position is not predeterminable in any way.

Accordingly, it is desired, even where the position of a shooting subject or object is not prejudgable, to perform approximation to the optimum shooting assistance by obtaining position information based on the inherent ID information.

In case more than two shooting subjects are present, it is often desired to change the decision as to which one of them is to be shot in accordance with the priority orders thereof.

It is therefore an object of this invention to avoid the problems faced with the prior art and provide an image information processing apparatus with increased usability.

To attain the foregoing object, this invention employs, as one example, a specific arrangement that is defined in the appended claims.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an image information processing apparatus capable of performing position detection using base stations.

FIG. 2 is a flow diagram of a sequence of the position detection.

FIG. 3 is a diagram showing an image information processing apparatus for position detection using a video camera.

FIG. 4 is a diagram showing a configuration of the video camera.

FIGS. 5A to 5E are diagrams showing a procedure for shooting while setting priorities to photographic subjects.

FIG. 6 is a diagram showing a liquid crystal display (LCD) panel during image pickup.

FIG. 7 is a diagram showing an on-screen display of the LCD panel indicating a present position of the shooting subject in a two-dimensional (2D) manner.

FIG. 8 is a diagram showing an on-screen display of the LCD panel indicating the position in a three-dimensional (3D) manner.

FIG. 9 is a diagram showing an on-screen display of the LCD panel indicating the position while letting it be superimposed on land map information.

### DETAILED DESCRIPTION OF THE INVENTION

Currently preferred embodiments of this invention will be described with reference to the accompanying figures of the drawing below.

### Embodiment 1

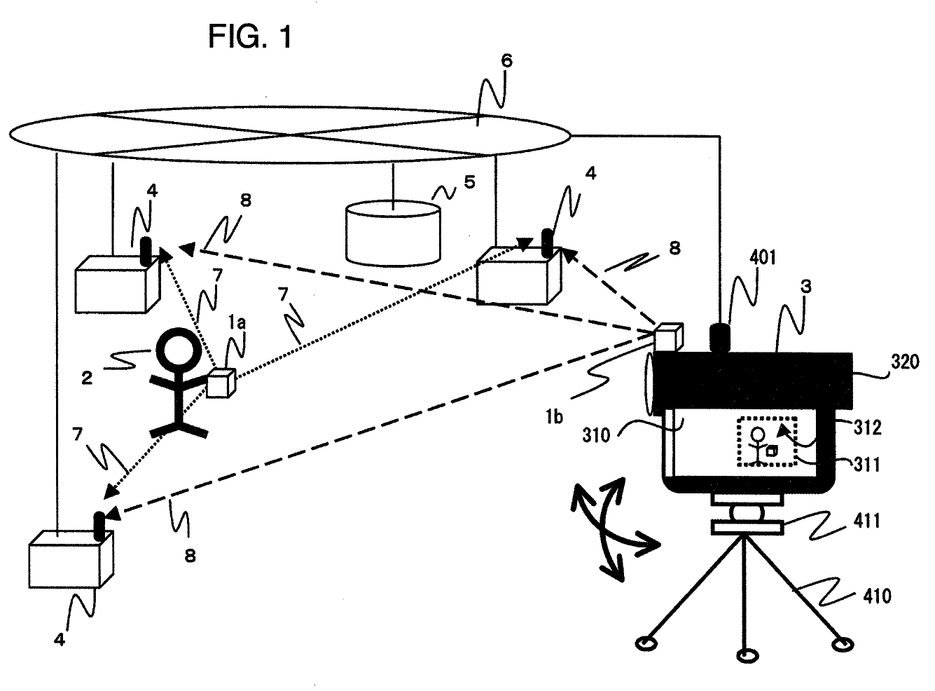

FIG. 1 depicts an exemplary system configuration of an image information processing apparatus with the aid of a wireless integrated circuit (IC) tag in accordance with one embodiment of the invention.

A photographic object 2 is a target subject of shooting, e.g., a person. This shooting subject 2 has a carriable wireless IC tag 1a for use as an identification (ID) information output device. The wireless IC tag 1a functions to transmit over the air a radio-frequency information signal 7 indicative of an ID unique thereto. This ID information signal 7 may include at least its unique ID information and a position measurement signal along with other data signals.

A video camera 3 with a built-in image pickup module such as an image sensor (not shown) is arranged to have a wireless IC tag 1b functioning as an ID information output unit, which tag may be externally attached to or internally built in the video camera 3. The wireless IC tag 1b transmits over-the-air an inherent ID signal—for example, a reference ID information signal 8 used for use as the reference when indicating positions on a plane in a coordinate system. The reference ID information signal 8 may contain its unique ID information and a position measurement signal along with other data signals. In the illustrative embodiment, position information is obtained by a position measurement technique based on trilateration principles utilizing an arrival time difference of radio signals. For this reason, at least three or more base stations 4 of a radio receiver are provided for receiving the shooting-subject ID information signal 7 transmitted from the wireless IC tag 1a and the reference ID information signal 8 of video camera 3 as sent from the wireless IC tag 1b and for transmitting via a network 6 to a position measurement server 5.

The position measurement server 5 of a position recognition unit adjusts a predetermined position measurement algorithm for performing position measurement based on the trilateration principles and measures, based on the trilateration principles using a radio signal arrival time difference for example, the present positions of the wireless IC tag 1a owned by the shooting subject 2 and the wireless IC tag 1b of video camera 3 to thereby extract the position information. The position information thus measured and extracted by the position measurement server 5 is sent forth to the video camera 3 via the network 6.

The video camera 3 includes a communication unit 401, which has wired or wireless communication functions. The communication unit 401 may have a radio communication antenna, which is typically built in the video camera 3. The network 6 also has wired or wireless communication functionalities.

The video camera 3 receives the position information extracted by the position measurement server 5 and then prepares position-related information by causing a coordinate converter unit (not shown) as built in the video camera 3 to perform coordinate conversion of the position information into 3D coordinates and causing an arithmetic processor unit (not shown) built in the video camera 3 to extract a relative distance between the video camera 3 and the shooting subject 2. The video camera 3 uses the extracted position-related information to output the position-related information for visual display on a monitor screen of a display unit of the video camera 3 and/or output it in an audible form from an audio output unit (not shown) and also permits a tracking control unit to control a controllable a camera platform 411 and/or a tripod stand 410 while performing panning and/or tilting for setup at a position capable of properly sensing an image of the shooting subject 2. In addition, based on the position-related information extracted at the video camera 3, zooming is performed at a certain ratio in such a way that the image is fitted to the angle of view of a liquid crystal display (LCD) panel 310. One exemplary way of displaying the position-related information is to enclose the shooting subject 2's wireless IC tag 1a by a rectangular frame 311. Another example is that a marking 312 is used to indicate the position of wireless tag 1a. Additionally, in a finder 320 also, the position-related information for indication of the wireless tag 1a may be visualized in a similar way to the LCD panel 310, although not specifically shown in FIG. 1.

After having set the video camera 3 in the state capable of shooting the target subject 2, resultant image pickup information is visually displayed at the LCD panel 310 while enabling the information involved, such as the ID information, position-related information and image pickup information, to be stored in a recorder unit (not shown). Thus it becomes possible to save a recording area and a battery pack of the video camera 3.

The video camera 3 also includes a built-in central processing device (having standard CPU functions) as a management unit (not shown) for control of respective components, which controls output of the ID information and the position-related information plus the sensed image information to external equipment and/or an external storage device.

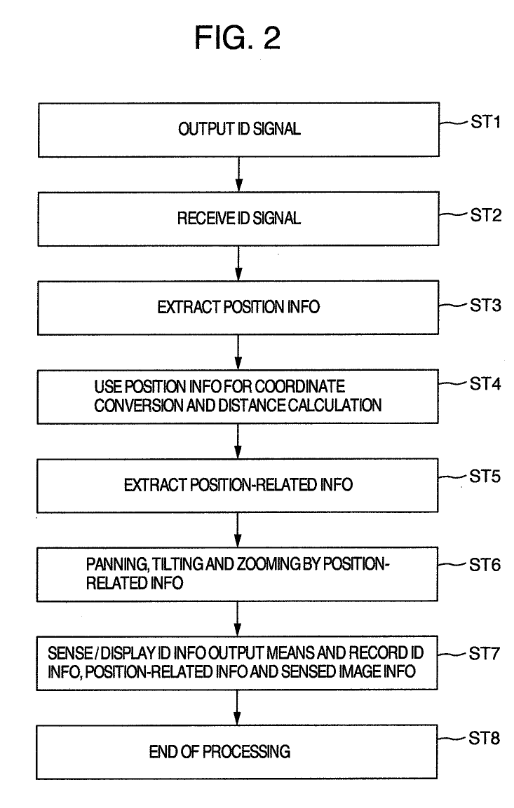

FIG. 2 is a flow diagram of a sequence of respective components shown in FIG. 1. The wireless IC tag 1a owned by the shooting subject 2 transmits over-the-air an object ID information signal 7 (at step ST1). This ID information signal 7 may include at least its unique ID information and a position measurement signal along with other data signals. The video camera 3 sends forth a reference ID information signal 8 (ST1).

There are at least three base stations 4, each of which is operatively responsive to receipt of the object ID information signal 7 as sent from the wireless IC tag 1a of shooting subject 2 and the reference ID information signal 8 of the video camera 3 (at step ST2), for transmitting them to the position measurement server 5 via the network 6.

The position measurement server 5 performs adjustment of the position measurement algorithm and measures present positions of the shooting subject 2 and the video camera 3 based on the trilateration principles using a radio signal arrival time difference for extraction of position information, for example (at step ST3).

The position information obtained is sent forth via the network 6 toward the video camera 3. This network 6 may be designed to have wired or wireless data communication channels. The video camera 3 is responsive to receipt of the position information, for applying 3D coordinate conversion to the position information and for calculating a distance between the video camera 3 and the shooting subject 2 (at step ST4).

The video camera 3 extracts, as the position-related information, the coordinates concerning positions and information as to positions, such as the distance (ST5).

Based on the extracted position-related information, the video camera 3 displays the position-related information on the monitor screen with or without audio output and controls the controllable camera platform 411 and the tripod 410 to thereby perform panning and tilting thereof, while performing zooming if necessary, for control at the position whereat the subject 2 is capable of being properly shot (ST6).

Once the state is set up for enabling the video camera 3 to shoot the subject 2, image pickup is performed to obtain sensed image information, which is displayed and recorded along with the ID information and position-related information (ST7).

According to the embodiment 1 stated above, it is possible for a camera user or photographer to readily find the target subject to be shot within the on-screen display of LCD panel. It is also possible to perform shooting through automated panning, tilting and zooming while keeping track of any possible motions of the subject under control of the tracking control unit and then display the sensed subject image in an appropriate display size with the aid of the scaling control unit.

### Embodiment 2

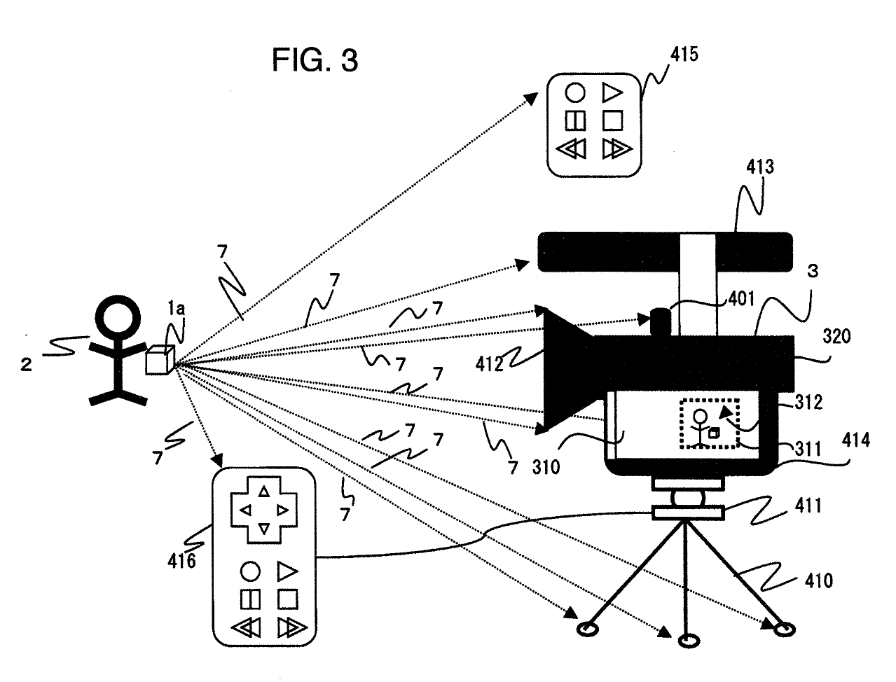

FIG. 3 illustrates one example of a system configuration of an image information processing apparatus using a wireless IC tag in accordance with another embodiment of the invention. The same reference numerals are used to indicate the same parts or components as those shown in FIG. 1, and a detailed explanation thereof is eliminated herein.

A video camera 3 of FIG. 3 has, as a radio receiver unit 4 to be later described, part of various types of connection devices and respective constituent components in order to detect a present position of a wireless IC tag 1a owned by a shooting subject 2. As an example, this embodiment has the radio receiver unit 4 including a communication unit 401, a tripod 410, a camera platform 411, a lens hood 412, a microphone 413, a housing 414 with LCD panel 310 received therein, a remote commander 415 for remote control of the video camera 3, a remote controller 416 for manipulation of the tripod 410, and a main-body 417 of the video camera 3, in which at least one of them has an antenna function for receipt of radio signals, although other antenna functional elements may be used. The radio receiver unit 4 receives a radio signal from the wireless IC tag 1a owned by the shooting subject 2 and extracts position information therefrom.

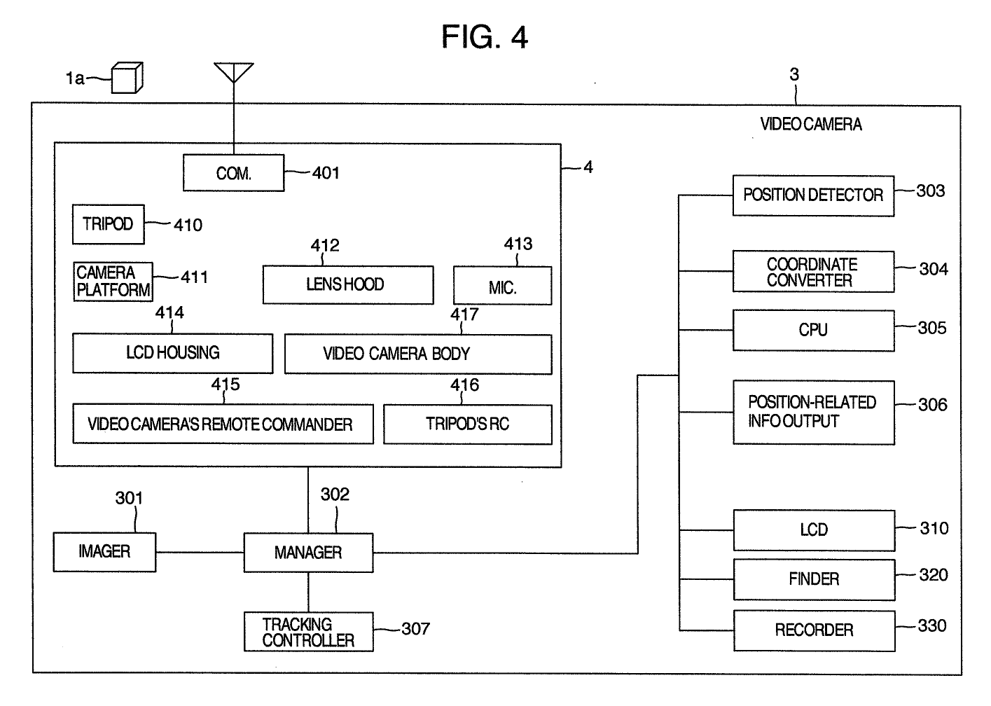

See FIG. 4, which shows an exemplary configuration of the video camera 3 of this embodiment. The video camera 3 includes the radio receiver unit 4. As previously stated in conjunction with FIG. 3, this radio receiver 4 includes the communication unit 401, the tripod 410, the camera platform 411, the lens hood 412, the microphone 413, the housing 414 with LCD panel 310 received therein, the remote commander 415 for remote control of the video camera 3, the remote controller 416 for manipulation of the tripod 410, and the video camera 3's main-body 417 that has therein the antenna function for receipt of radio signals.

An ID information signal of the shooting subject 2 which is received by the video camera 3 and radio signals as received by a position detector unit 303—i.e., ID information signal and position measurement signal—are used for a prespecified kind of position measurement processing so that the shooting subject's position information is extracted. The position information extracted is converted at a coordinate converter unit 304 into 3D coordinate data, followed by extraction of coordinate information therefrom. In addition, at an arithmetic processing unit 305, a relative distance between the wireless IC tag 1a and the video camera 3 is computed by prespecified algorithm. The position-related information as extracted by the coordinate conversion/extraction unit 304 and arithmetic processor unit 305 is output by a position-related information output unit 306.

Based on the output position-related information, a tracking control unit controls the tripod 410 and camera platform 411 in accordance with a prespecified algorithm to perform panning, tilting and/or zooming for adjustment of the direction of the video camera 3 in such a way as to enable proper image pickup of the wireless IC tag 1a.

After having adjusted the direction of the video camera 3 in this way, when an environment for image pickup of the wireless IC tag 1a is established, it becomes possible to output sensed image information from an image pickup unit 301. Consequently, it is after the shooting subject 2 becomes photographable that the image pickup information and ID information plus position-related information are output to the LCD panel 310, finder 320 and recorder unit 330. The above-noted respective components and signals are controlled by a management unit 302 using a predetermined sequence control scheme.

According to the above-stated embodiment 2, by performing the sequence control of shooting and recording operations until the environment for shooting the target subject is established, it is possible to save electrical power consumption and recording/storage capacity.

### Embodiment 3

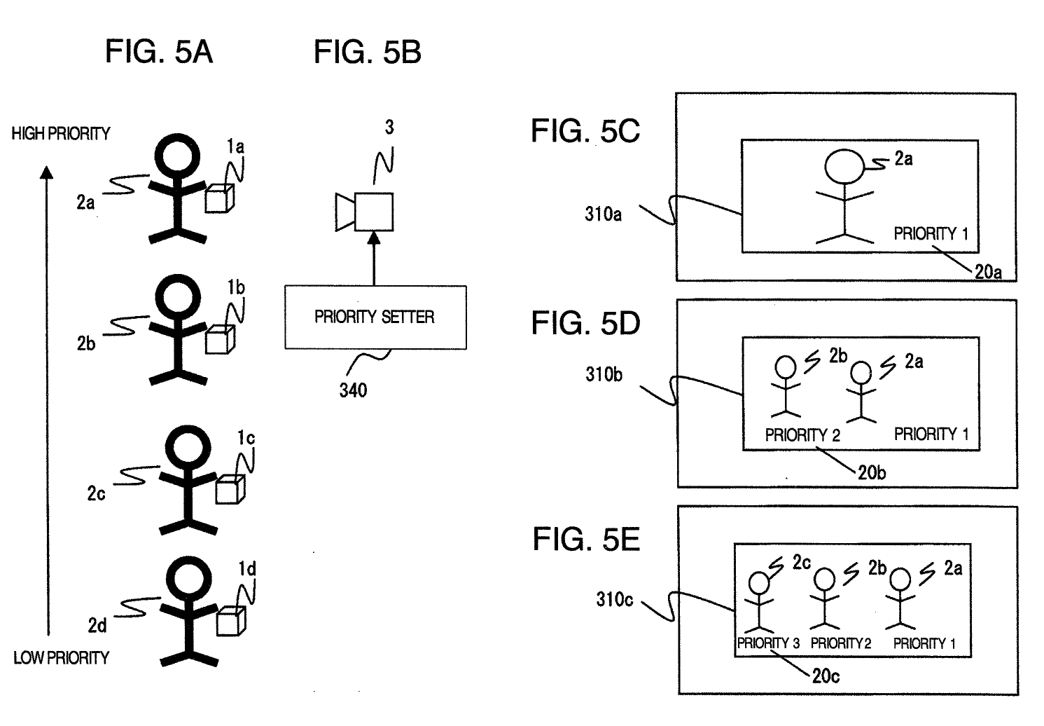

FIGS. 5A to 5E show an exemplary system configuration of wireless tag-used image information processing apparatus also embodying the invention and several ways of displaying a sensed image on LCD panel.

In FIG. 5A, a vertical axis is shown on the left hand side, which indicates some levels of the order of priority. The higher the level, the higher the priority. More precisely, a shooting subject 2a is the highest in priority, followed by 2b, 2c and 2d.

As shown in FIG. 5B, the video camera 3 is operatively associated with a priority order setup unit 340. In this embodiment the shooting subjects 2a-2d have wireless IC tags 1a-1d, respectively. The priority orders of these tags are set up by the priority setter 340 via wired or wireless data transfer channels. The priority setup may be done prior to shooting or alternatively may be changed in responding to an instruction from the user. The wireless IC tags may be designed so that their priorities are updated automatically in accordance with the surrounding environment and shooting time, etc. This is in order to appropriately deal with the priorities which are variable not only by the user's own will but also by the surrounding environment and shooting time.

A display image 310a of LCD panel 310 shown in FIG. 5C indicates display contents of a sensed image of only the shooting subject 2a that is the highest in priority order. An on-screen text indication 20a is the priority of the shooting subject 2a being displayed on LCD panel 310. This on-screen priority indication can be selectively turned on and off. Suppose that in this case, settings are made in such a way as to shoot the target subject with the highest priority, as an example.

Similarly, an LCD display 310b of FIG. 5D indicates display contents of a sensed image of the shooting subjects 2a and 2b which are the highest and the second highest in priority order. An on-screen indication 20b is the priority of the additional shooting subject 2b being displayed on the LCD panel 310. In this case, settings are made in such a way as to shoot the first priority subjects 2a and the second priority subject 2b, by way of example. Similarly, an LCD display 310c of FIG. 5E indicates display contents of a sensed image of three shooting subjects 2a, 2b and 2c which are of the highest, second highest and third highest priority orders. An on-screen indication 20c is the priority of the third shooting subject 2c being displayed on the LCD panel.

Alteration of the shooting range (selection of a shooting subject or subjects) in accordance with the priority orders is done by controlling the camera platform 411 of video camera 3 to perform panning, tilting and/or zooming. It is also possible to arrange the LCD panel 310 to visually display the priority order(s); in this case, the shooting range is changeable by the user's own operations.

According to the embodiment 3, it is possible to perform tilting, panning and zooming controls in such a way as to enable achievement of any intended shooting while setting the user's preferred shooting subject and not-preferred ones and causing a shooting subject with higher priority to reside at or near a central portion of the display screen.

### Embodiment 4

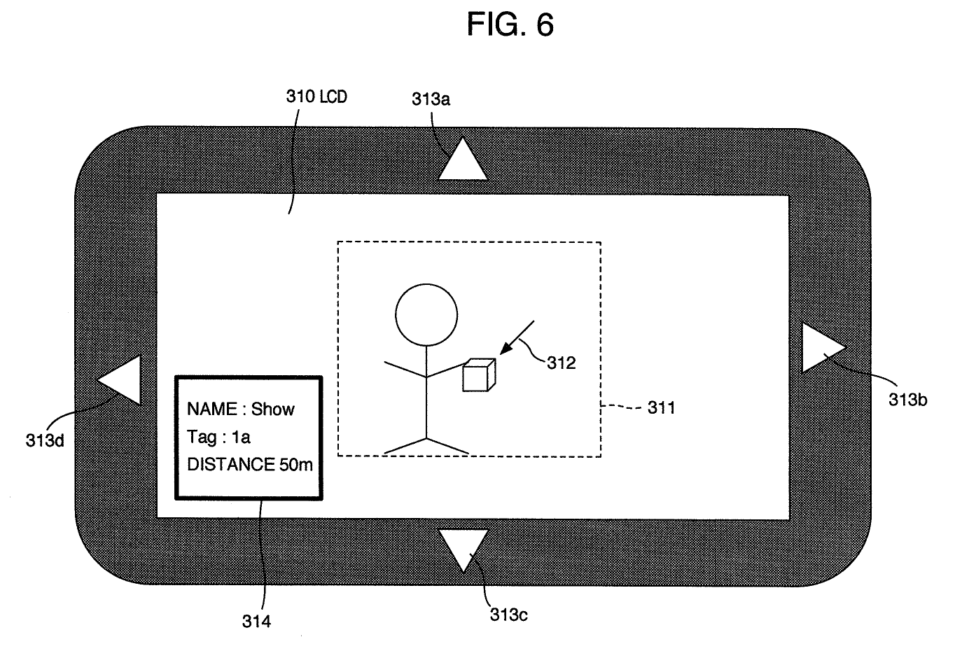

FIG. 6 shows one embodiment of the on-screen display image during shooting of a target subject at a part of the LCD panel 310 of video camera 3.

A rectangular dotted-line frame 311 indicates the fact that a chosen shooting subject and its wireless IC tag 1a are recognized and captured on the display screen. An arrow 312 indicates a present position of the wireless IC tag 1a. At a lower left corner of LCD display screen, the position-related information is visually indicated in a text form.

In this embodiment, the shooting subject's name, tag name and a distance up to the shooting subject are indicated. Triangle-shaped indicators 313a, 313b, 313c and 313d are laid out around the outer frame of the LCD panel 310 for indicating a direction of the wireless tag owned by the shooting subject of interest. In case the shooting subject is out of the LCD display area, one of these triangle indicators 313a-313d is activated to suggest that it exists in which direction when looking at from the camera.

In this example the shooting subject resides within the display area of LCD panel 310, so none of the wireless tag direction indicators 313a-313d are displayed. When displaying, a light source, such as a light-emitting diode (LED) backlight, is driven to turn on or blink, thereby enabling the user to intuitively grasp the position and distance. An example is that if the target shooting subject comes closer to the camera side, the LED light source is lit brightly or blinked at shortened time intervals to thereby indicate that it is very close to the camera. Adversely, if the target subject is far from the camera, the LED backlight is lit weakly or blinked slowly. It is also possible to turn on the LED in different color in the event that the target becomes no longer recognizable resulting in the lack of position detectability. The LED lighting/blinking scheme and the light source's color and the form of the wireless tag direction indicators 313a-313d as used in this embodiment are illustrative of the invention and not to be construed as limiting the invention. Regarding the on-screen frame 311 indicating the shooting subject and the arrow 312 indicating the position of wireless IC tag 1a, these are not exclusive ones. As for the position-related information, the contents being displayed on the screen may be modifiable by those skilled in the art in various ways without requiring any inventive activities.

According to the embodiment 4, it is possible to notify the photographer of the best possible direction or angle for shooting his or her preferred target object by displaying guidance therefor on the screen of the display means along with material information as to the object.

### Embodiment 5

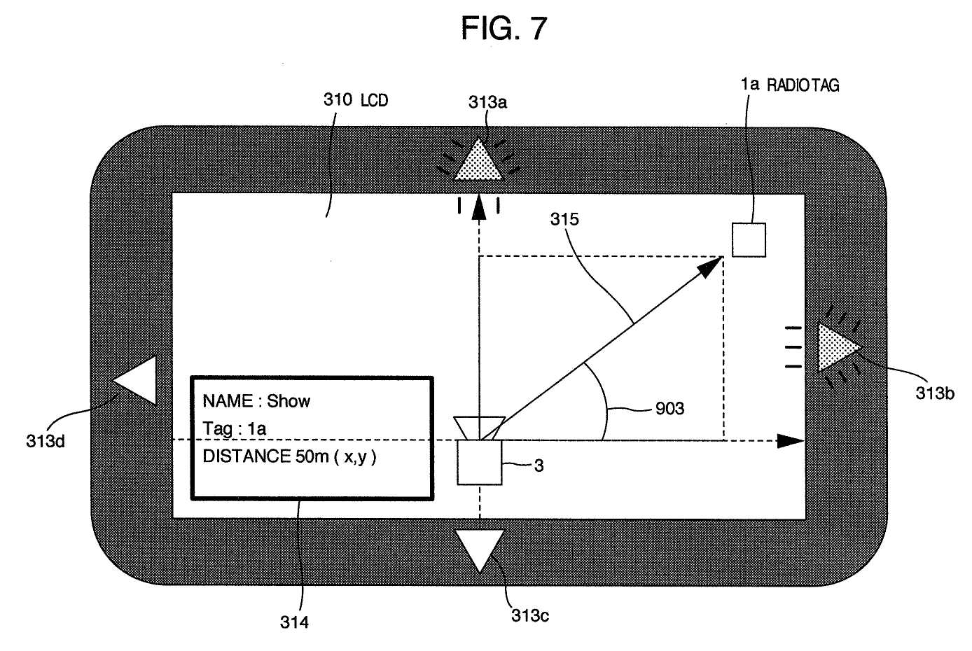

FIG. 7 shows one embodiment for displaying in a two-dimensional (2D) coordinate system the information for guiding to the detected position of the wireless IC tag 1a of a shooting object at part of LCD panel 310 of video camera 3.

On the screen, x- and y-axes are displayed, with an icon of video camera 3 being displayed at the origin of coordinates. In the coordinate space, an icon of wireless IC tag 1a is displayed. An arrow 315 is used to indicate a vectorial direction in which the wireless IC tag 1a exists. Any one of wireless tag direction indicators 313a-313d is driven to turn on or blink for output of the guidance information indicating the wireless IC tag's position and direction. In this example two indicators 313a and 313b blink to indicate the state that the guidance information is being output. At a position-related information display section 314, the x- and y-coordinate values are indicated along with a relative distance of the video camera 3 up to the wireless IC tag 1a.

According to the embodiment 5, it is possible to suggest to the photographer the best possible direction or angle for shooting his or her preferred target object by displaying guidance therefor at the display means along with material information as to the object with the use of a 2D coordinate system. This makes it possible to assist the photographer.

### Embodiment 6

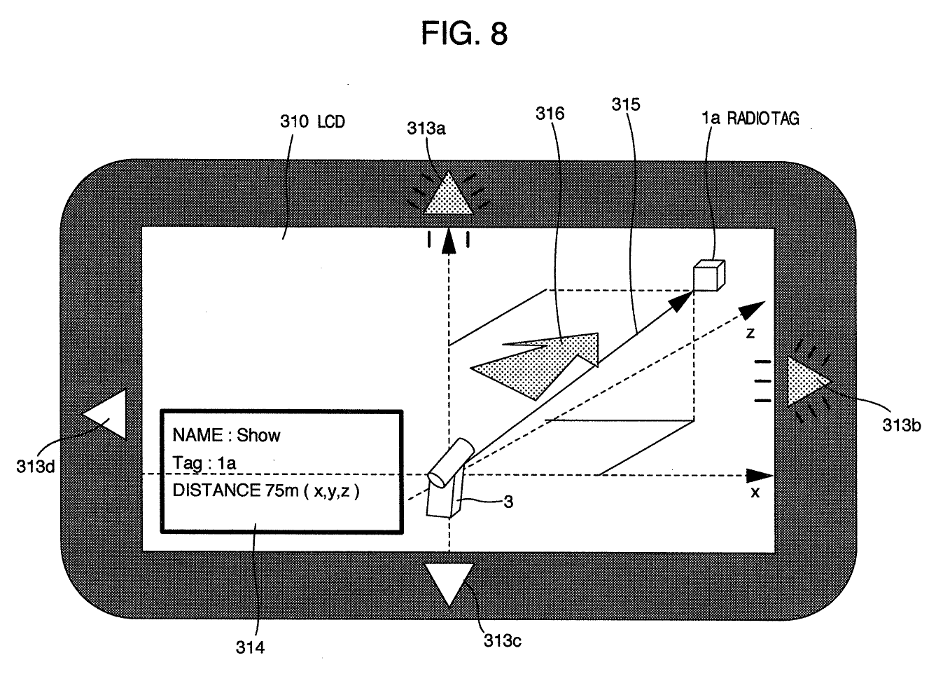

FIG. 8 shows one embodiment for displaying in a three-dimensional (3D) coordinate system the information for guidance to the detected position of the wireless IC tag 1a of a shooting object at part of LCD panel 310 of video camera 3.

On the screen, x-, y- and z-axes are displayed, with an icon of video camera 3 being displayed at the origin of coordinates. In the coordinate space, an icon of wireless IC tag 1a is displayed. An arrow 315 used indicates a vectorial direction in which the wireless IC tag 1a exists. A 3D graphics arrow image 316 is additionally displayed for enabling the user to intuitively recognize the position and direction of the wireless IC tag 1a. This 3D arrow 316 is variable in size, direction and position while keeping track of movements of the video camera 3 and/or the wireless IC tag 1a. Wireless tag direction indicators 313a-313d are selectively lit brightly or blinked for output of guidance information indicating the wireless IC tag's position and direction.

In this embodiment the indicators 313a and 313b blink to indicate the state that the guidance information is being output in a similar way to the embodiment 5 stated supra. At a position-related information display section 314, the x-, y- and z-coordinate values are indicated together with a relative distance of the video camera 3 up to the wireless IC tag 1a.

According to the embodiment 6, it becomes possible to suggest to the photographer the best possible direction or angle for shooting his or her preferred target object by displaying guidance therefor at the display means along with material information as to the object with the use of a 3D coordinate system, thereby making it possible to assist the photographer.

### Embodiment 7

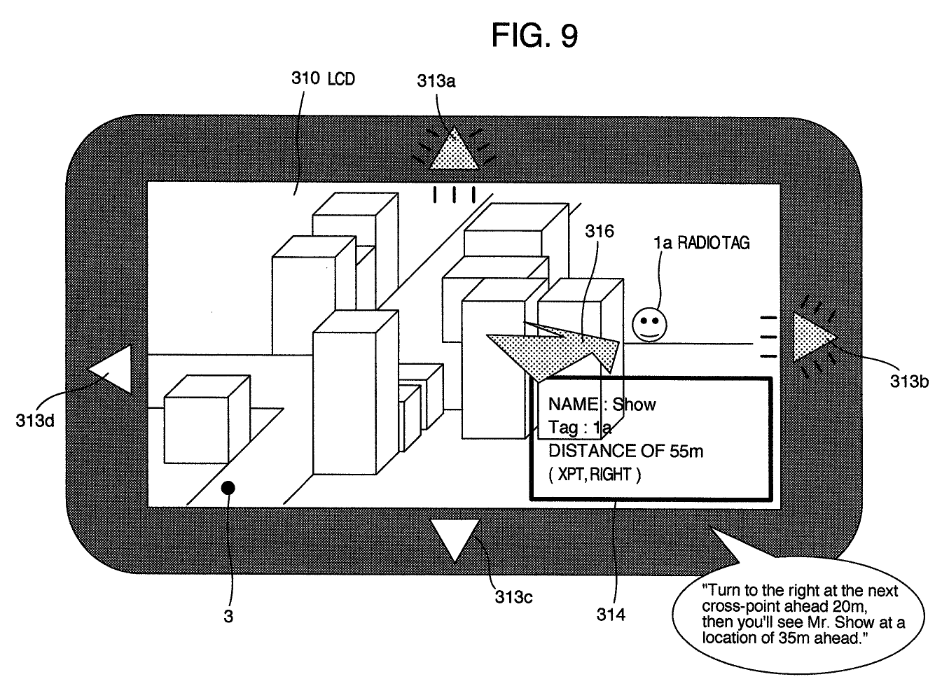

FIG. 9 shows one embodiment for displaying on a 3D land map image the information for guidance to the detected position of the wireless IC tag 1a of a shooting object at part of LCD panel 310 of video camera 3.

In this embodiment an icon of video camera 3 and an icon of wireless IC tag 1a are displayed along with an ensemble of 3D graphics images or “caricatures” indicating buildings and roads or streets at a location in a mid city with many buildings. Information of such 3D building images may be prestored in the video camera 3 by using its associated external recording media or internal memory or else or, alternatively, may be transmitted over-the-air via radio channels. A 3D icon 316 indicative of a present position of the wireless IC tag 1a is displayed in the form of a bird's eye view. As in the previous embodiment, the 3D arrow 316 is variable in its size, direction and position while keeping track of movement or “migration” of the video camera 3 and/or the wireless IC tag 1a, thereby enabling the user to intuitively recognize a present position and direction of wireless IC tag 1a. The map information being displayed also is seen to move like a real scene as the video camera 3 moves. Additionally as in the embodiment 6, any one or ones of the wireless tag direction indicators 313a-313d are lit brightly or blinked for output of a present position and direction of the wireless IC tag 1a.

In this embodiment the indicators 313aand 313bblink to indicate the state that the guidance information is being output in a similar way to that of the embodiment 6 stated supra. In a position-related information display section 314, information that suggests turning to the right at a street crossing or intersection is visually indicated along with a relative distance between the video camera 3 and wireless IC tag 1a. Additionally in this example, an audio output means, such as a speaker module or earphone(s), is provided to output audible guidance information, such as a synthetic audio sound resembling human voice which says, “Turn to the right at the next cross-point ahead 20 m, and soon you'll find Mr. Show at a location of 35 m ahead.

According to the embodiment 7 stated above, even when a present position of the shooting subject of interest is hardly recognizable in advance or in cases where the subject being displayed on LCD panel 310 goes out of the display frame and thus becomes no longer trackable nor recognizable, it is still possible to notify the user of the exact position of the shooting subject by means of images, audio sounds and/or texts. This provides helpful assistance for the photographer's intended shooting activity.

Although the invention has been disclosed and illustrated with reference to particular embodiments, the principles involved are susceptible for use in numerous modifications and alterations which will readily occur to persons skilled in the art. For example, in the embodiments as disclosed herein, all the components thereof should not necessarily be employed at a time and may be modifiable so that part of an embodiment is replaceable by its corresponding part of another embodiment or, alternatively, the configuration of an embodiment is at least partially added to another embodiment.

According to the embodiments stated supra, it is possible to provide the position information to the video camera which has traditionally been operated by a user to perform image pickup for shooting any target object in a way relying upon human senses only. This in turn makes it possible to permit the user to shoot, based on the shooting-assistant/guidance information, his or her preferred subjects or objects with increased efficiency. In addition, combining the automatic panning/tilting mechanism enables the camera to perform image-pickup/shooting operations in an automated way.

According to the invention disclosed herein, execution of the wireless IC tag-aided position detection makes it possible to achieve efficient shooting of any target objects or subjects and recording image data while at the same time avoiding accidental occurrence of object-shooting failures or “misshots” in cases where a target subject is out of sight due to its unexpected motions or in cases where it is unpredictable when the subject appears in the scene. Additionally, by managing for recording the ID information and the position-related information plus the priority order information along with the image data of the shooting subject recorded and by using the information of the aimed shooting subject, it is possible to conduct a search for video-recorded information with the aid of the position information and ID information and also possible to achieve high-accuracy image pickup information classification and organization. According to this invention, even in a situation that there are many children who are similar in costume and physical attributes, e.g., in sports festivals, it is possible to efficiently shoot a target child only. It is also possible to output only the preferred shooting subject to external recording media and/or external equipment.

Additionally the mechanism is provided for notifying the user of a present position of the shooting subject by means of images, audio sounds and/or texts in case its present position is not prerecognizable or in case the subject being displayed in the finder or on the LCD screen goes out of the display frame and thus becomes no longer trackable nor recognizable, it is possible to provide helpful assistance for the photographer's intended shooting or to enable achievement of automated shooting. In addition, by designing the radio receiver of image pickup device to contain the position detector, it is possible to attain the foregoing objectives by the imaging device per se even in the absence of any position-detecting environments.

According to this invention, it is possible to provide the usability-increased image information processing apparatus.

It should be further understood by those skilled in the art that although the foregoing description has been made on embodiments of the invention, the invention is not limited thereto and various changes and modifications may be made without departing from the spirit of the invention and the scope of the appended claims.

1. An image information processing apparatus comprising:
an image pickup unit for sensing an image of an object to be shot, the object having a wireless tag;
a communication unit for communicating with the wireless tag of said object;
a position detection unit responsive to receipt of information from said communication unit for detecting information relating to a position; and
display means for displaying the position of said object by use of the position-related information detected by said position detection unit.

2. An image information processing apparatus according to claim 1, further comprising:
a tracking control unit responsive to receipt of position information of said object for performing image pickup while tracking movement of said object.

3. An image information processing apparatus according to claim 1, further comprising:
a scaling control unit responsive to receipt of position information of said object for modifying an on-screen display image of said object so that its size is changed to a prespecified display size while letting the display image be fitted to an angle of field.

4. An image information processing apparatus according to claim 1, further comprising:
a priority order setup unit for permitting image pickup while setting priority orders to a plurality of wireless tags.

5. An image information processing apparatus according to claim 1, wherein said display means visually displays the position of said object in any one of a two-dimensional coordinate system and a three-dimensional coordinate system.

6. An image information processing apparatus according to claim 1, further comprising:
audio output means for outputting information as to the position of said object in an audible form.

7. An image information processing apparatus according to claim 1, further comprising:
a radio receiver unit having a built-in position detector unit for receiving a radio signal of a wireless tag and for performing position detection.
